(19) United States
(12) Patent Application Publication
(10) Pub. No.: US 2024/0385744 A1
(43) Pub. Date: Nov. 21, 2024

(54) MindGallery: AI Powered Digital Art Display with Vocal Command & Touchscreen Interface

(71) Applicants: Jeremey White, Miami, FL (US); Payton Parr, Jersey City, NJ (US)

(72) Inventors: Jeremey White, Miami, FL (US); Payton Parr, Jersey City, NJ (US)

(21) Appl. No.: 18/674,878

(22) Filed: May 26, 2024

Related U.S. Application Data
(60) Provisional application No. 63/502,675, filed on May 17, 2023.

(51) Int. Cl. G06F 3/04883; G06F 3/16; G06T 11/60

(52) U.S. Cl. CPC G06F 3/04883; G06F 3/167; G06T 11/60; G06T 2211/441

(57) ABSTRACT

MindGallery is an advanced AI-powered digital art display. It features a 32″ touchscreen display utilizing touch and vocal commands to generate, display, and edit AI artwork. Wi-Fi and Bluetooth connectivity will allow users to easily upload photos for display/AI editing and also to export created pieces. The MindGallery software employs natural language processing and large language models for accurate prompt transcription and dynamic interactions. Users can vocally edit and replace specified regions within their generated art using computer vision and generative AI models. Over-the-air updates ensure continuous enhancement and additional features for all users. A robust framework supports hosting first-party, second-party, and third-party applications, positioning MindGallery as an eventual physical hub for diverse AI-based visual arts programs and tools. MindGallery aims to transform any space into an immersive art gallery, allowing users the chance to exercise a bit of creativity each day.

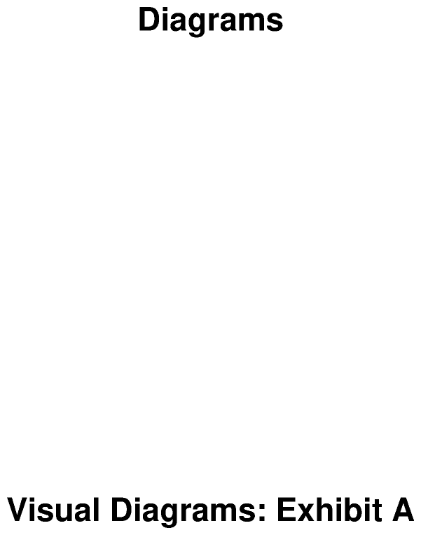

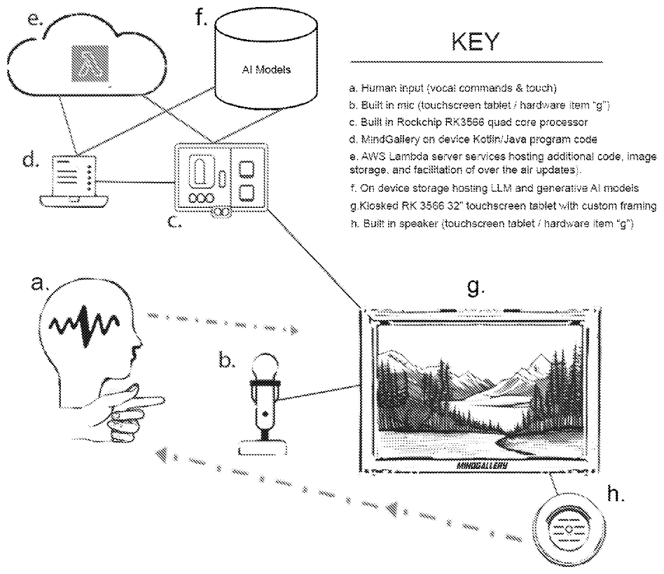

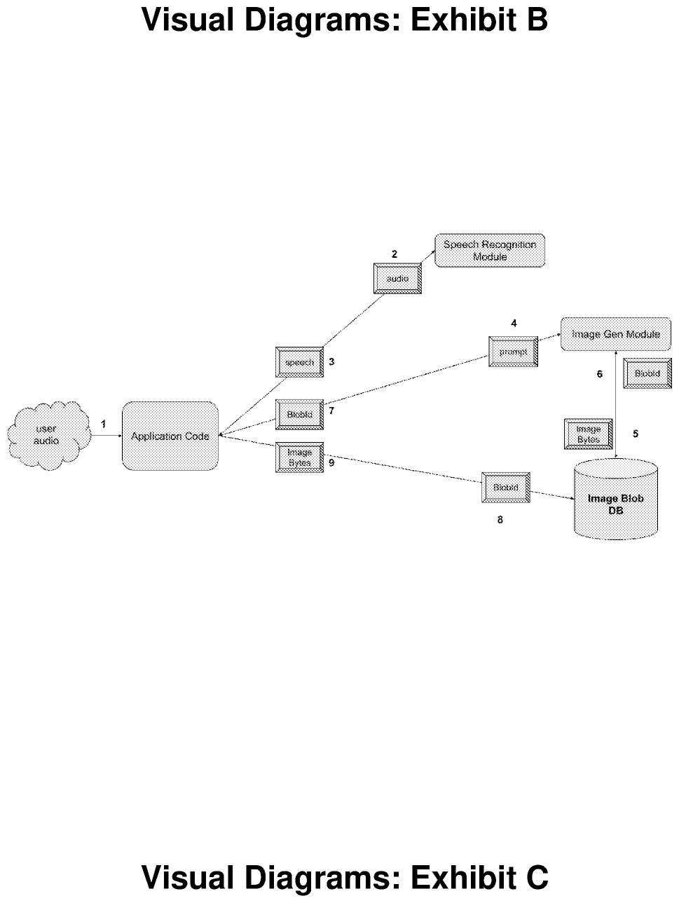

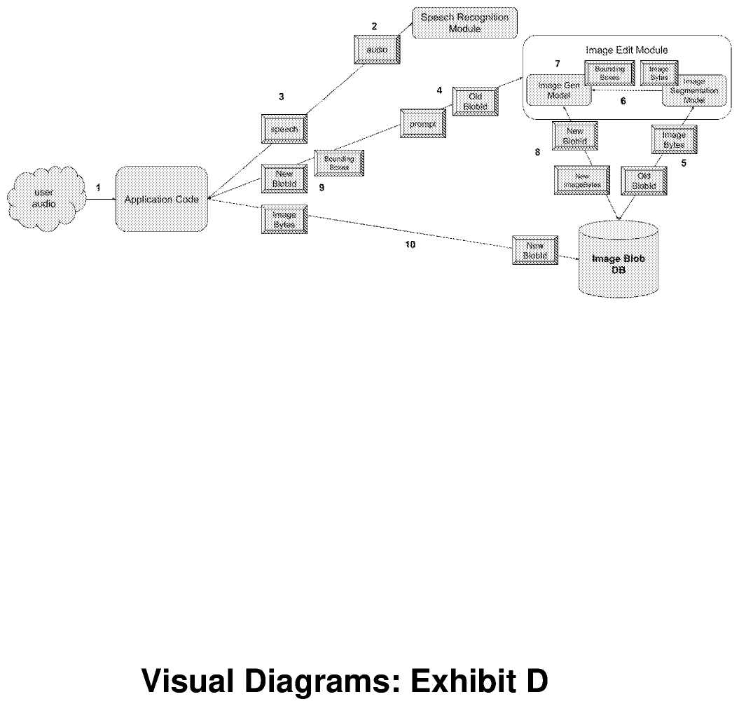

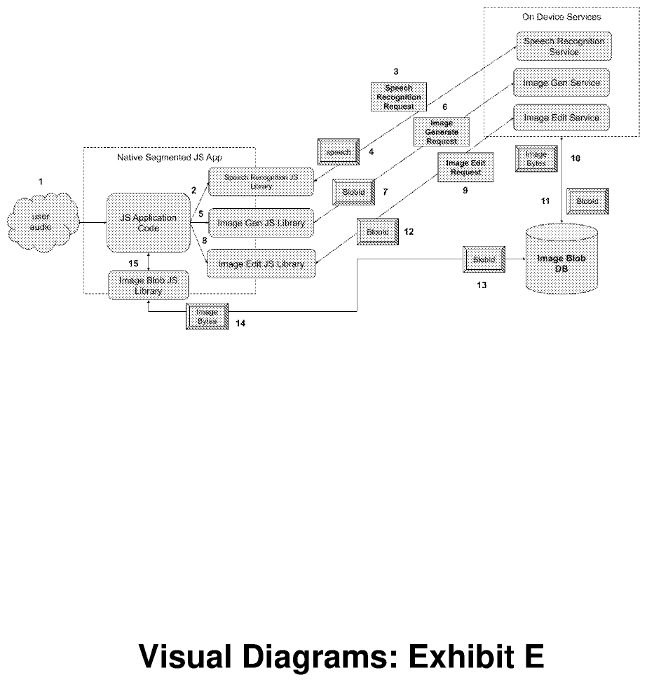

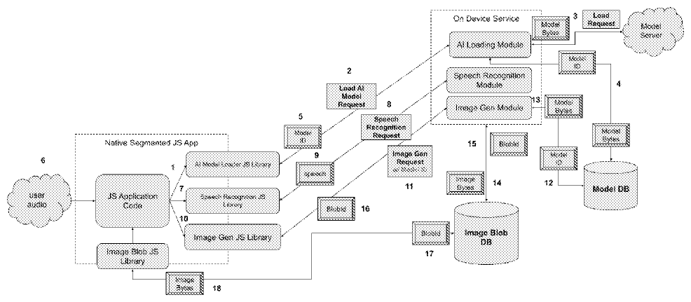

### INTRODUCTION

The realm of modern art has undergone a significant transformation in recent years, propelled by advancements in digital technology. Among these advancements, digital art displays have emerged as a worthy medium, offering new ways to experience and interact with art. We now explore the rise of digital art displays, their integration into the world of modern art, the burgeoning popularity of NFTs, rise of generative AI, and explore what a digital art display should be in this new era of technology.

### The Rise of Digital Art Displays

Digital art displays have become a staple in contemporary art exhibitions and private collections. These displays offer a dynamic and versatile platform for showcasing art, enabling artists and curators to present their works in innovative ways. Unlike traditional static frames, digital displays can exhibit multiple pieces of art in a single frame, provide interactive features, and adapt to various settings.

Major art fairs, such as Art Basel, have embraced digital art displays, recognizing their potential to enhance the viewer's experience. Art Basel, renowned for its influence in the global art market, has incorporated digital displays to showcase cutting-edge digital art, photography, video art, interactive installations, and NFTs. These displays provide a modern aesthetic that appeals to contemporary audiences and aligns with the digital age.

### The NFT Phenomenon

Non-fungible tokens (NFTs) have revolutionized the art market by providing a new way to own, trade, and display digital art. NFTs are unique digital assets verified using blockchain technology, ensuring the authenticity and ownership of digital artworks. The rise of NFTs has led to an explosion of digital art, with artists exploring new mediums and creating works specifically for digital consumption.

The NFT boom of the early 2020s was closely tied to the cryptocurrency surge, with many artists and collectors drawn to the decentralized and transparent nature of blockchain technology. Notable examples from this period include Beeple's “Everydays: The First 5000 Days,” which sold for $69.3 million at Christie's in March 2021, marking a pivotal moment for digital art and NFTs. This period also saw the emergence of platforms like OpenSea and Rarible, which facilitated the buying, selling, and trading of NFTs, further fueling the market's growth.

Culturally, the NFT boom intersected with a broader digital transformation, where social media and online communities played crucial roles in promoting and disseminating digital art. The accessibility of these platforms allowed a diverse range of artists to reach global audiences, democratizing the art world and challenging traditional gatekeepers.

### The Rise of AI and Generative Art

The advent of artificial intelligence (AI) has opened up new frontiers in the creation and appreciation of digital art. Generative AI, in particular, has gained prominence for its ability to create original artworks using algorithms and machine learning. The early 2020s saw significant strides in this field, with models like OpenAI's GPT-3, DALL-E, CLIP, Google's DeepDream, and Nvidia's StyleGAN revolutionizing the way we perceive and interact with art.

### Cultural and Historical Context

The rise of generative AI art coincided with a broader cultural shift towards digital and computational creativity. Early AI art experiments, such as Google's DeepDream in 2015, which created dream-like, hallucinogenic images, captured public imagination and highlighted the potential of AI in creative domains. By the early 2020s, the development of transformer models like GPT-3 by OpenAI marked a significant leap, showcasing the ability of AI to generate coherent and contextually rich text.

This period also saw artists like Mario Klingemann and Refik Anadol gaining recognition for their AI-generated works. Klingemann, known for his pioneering work in neural art, used GANs to create pieces that blurred the line between human and machine creativity. Anadol's data-driven installations, such as “Machine Hallucinations,” utilized vast datasets and AI algorithms to transform architectural spaces into immersive art experiences.

### How Conversational LLM Models Work

Large Language Models (LLMs) like GPT-3 and its successors operate by training on vast datasets comprising text from books, articles, and websites. These models use a transformer architecture, which allows them to process and generate text by predicting the likelihood of a word or phrase given its context. Transformers rely on self-attention mechanisms to weigh the importance of different words in a sentence, enabling the model to capture nuanced meanings and relationships.

These models function through a process known as unsupervised learning, where they identify patterns and relationships within the data without explicit human labeling. Pre-training involves exposing the model to a large corpus of text, allowing it to learn grammar, facts about the world, and some reasoning abilities. Fine-tuning then adapts this knowledge to specific tasks, such as translation or text generation, enhancing the model's performance on those tasks.

### Methods of Creating Generative AI Art

Generative AI models employ various techniques to create art across different mediums:
1. Text-to-Image:
   DALL-E: This model generates images from textual descriptions using a transformer architecture. By interpreting natural language, DALL-E can create novel images that correspond to the descriptions, from realistic renderings to imaginative, surreal compositions.
   Stable Diffusion: Similar to DALL-E, this model uses diffusion processes to transform random noise into coherent images based on text prompts. It excels in generating high-resolution, detailed images.
2. Image-to-Image:
   Neural Style Transfer: This technique uses convolutional neural networks (CNNs) to apply the artistic style of one image to the content of another, producing hybrid images that combine the elements of both.
   Pix2Pix: This GAN-based model generates images from other images, such as transforming sketches into photorealistic pictures or day images into night scenes.
3. Text-to-Video:
   CogVideo: By extending the principles of text-to-image generation to the temporal domain, CogVideo generates video sequences from textual descriptions. Each frame is generated in a way that maintains continuity, creating a coherent video narrative.
4. Image-to-Video:
   GAN-Based Models: These models, such as StyleGAN, can animate static images by generating frames that simulate motion. They are used in applications like “deepfake” technology, where static images of faces are animated to speak or express emotions realistically.
5. Video-to-Video:
   Vid2Vid: This approach uses GANs to transform videos, altering visual elements while preserving the original motion and structure. Applications include converting black-and-white footage to color, enhancing video quality, and even changing the appearance of characters within a video.

### Hardware Use Cases and Current Developments

While the software capabilities of generative AI have advanced rapidly, hardware use cases for such technology are only now being developed. The integration of generative AI into consumer and professional hardware remains limited, with most applications occurring in software environments. However, the potential for hardware solutions—such as interactive digital art displays, AI-powered creative tools, and real-time generative content production—is vast.

### The Future of Digital Art Displays and AI

The integration of digital art displays and AI technologies would herald a new era in the world of art. As AI continues to evolve, we can expect even more sophisticated and creative applications in art generation and display. The Mindgallery display, with its advanced features and user-friendly design, is poised to lead this revolution, offering a platform for both artists and art enthusiasts to explore the limitless possibilities of AI-generated art.

The use cases and abilities of devices like the Mindgallery will undoubtedly grow over time, as new AI models and technologies are developed. This continuous evolution will ensure that digital art displays remain at the forefront of modern art, providing ever more immersive and interactive experiences.

### SUMMARY OF INVENTION

MindGallery is a groundbreaking AI-powered digital art frame that redefines the traditional digital art display experience. As the first-ever AI powered dedicated digital art display, it empowers users to generate, display, and edit original AI artwork through intuitive touch and vocal commands. This device serves as one of the first examples of ready-to-buy AI hardware in the world. The easy to use physical interface opens the door to AI fanatics and first time users alike.

The MindGallery art frame features a custom framed 32″ touchscreen display powered by a Rockchip 3566 quad-core processor. Seamless Wi-Fi connectivity allows the frame to leverage existing generative AI models, enabling users to generate AI art with simple vocal commands. Advanced natural language processing techniques facilitate accurate transcription and interpretation of user prompts. Bluetooth compatibility and Wi-Fi connectivity will enable photo upload and export.

The in-house developed MindGallery software provides a user-friendly interface that simplifies the art generation process. This includes the ability to automatically enhance prompts, select preset artistic styles, and generally customize the device for your specific needs. Leveraging of LLM technology also facilitates intent detection which opens the door for vocal navigation, vocal settings selection, dynamic conversational responses, and endless prompt iteration. Integration with AWS Lambda ensures seamless image retrieval and facilitates control and monitoring of usage.

MindGallery also allows users to edit their generated art vocally. Users can command the system to edit, change, or replace specific regions of previously generated art. Using a computer vision model and proprietary algorithms, the system extracts these snippets, generates replacement snippets using generative AI, and seamlessly integrates them into the existing artwork, enabling dynamic AI editing controlled solely by voice commands. Incorporation of photo upload will open the door to endless professional use cases here for designers, teachers, and more.

Over-the-air updates will ensure continuous enhancement of the model's capabilities into the future, for all users. The framework is set to introduce an animation feature utilizing various existing and eventually proprietary AI models. Additionally, various plans are underway to implement community building features. A robust framework supports hosting 1st, 2nd, and 3rd party applications, establishing MindGallery as an eventual physical hub for a wide array of AI-based visual arts programs and tools.

MindGallery represents a paradigm shift in art appreciation and enjoyment. It transcends traditional static art frames, introducing dynamic AI-generated art that adapts to users' preferences. The current open framework puts the invention on a path for perpetual growth, allowing for endless expansion and use cases. This invention promises to transform any space into an immersive art gallery, enriching daily life and bringing an opportunity to exercise a bit of creativity each day

### DIAGRAM DESCRIPTIONS

### Exhibit A

This exhibit primarily focuses on the flow of user interaction with the physical components of the device. The user interacts with the device by touching the screen and then verbally saying what they want to be visually generated or detailing a desired edit of the image currently displayed on the device. This includes utilization of various existing generative AI models, speech recognition algorithms, and more.

### Exhibit B

This exhibit primarily focuses on the software flow of image generation utilized by the MindGallery device. Covered within is the flow of user speech, speech recognition, image generation via image generation models based on initial speech, and display of generated image on device.

### Exhibit C

This exhibit details the software flow of the image editing process on the MindGallery device using user audio inputs. User audio is captured by the device's microphone and sent to the Speech Recognition Module, which detects the speech that is contained in the audio (if any). The application processes the speech into a prompt. Then the application retrieves the Blob ID of the image currently displayed on the device and loads its bytes. Blob ID (mentioned here and throughout) is an identifier used to look up a “blob” of bytes in storage. Based on the prompt and image bytes, the Image Edit Module selects parts of the image and represents this selection as bounding boxes. Using one or more generative AI models, the Image Generation Module generates replacement images for the bounding boxed segments of the original image and then merges those replacement image segments with the original image to form a new image. The new image bytes are stored in the Image Blob Database, generating a new Blob ID. The final image is retrieved using this new Blob ID and displayed on the device.

### Exhibit D

This exhibit demonstrates the preferred embodiment of hosting 1st, 2nd, and 3rd party applications (apps) on device. Segregated apps can interact with on-device AI services seamlessly. Segregated apps run using native JavaScript (JS) code. The exhibit demonstrates an example sequence of events where user audio is captured by the device and sent to a native JS application. The JS app utilizes a MindGallery provided Speech Recognition JS Library to convert the audio into speech via sending the audio to Speech Recognition Service. The application converts the speech into a prompt, then sends the prompt to the Image Gen service (via MindGallery provided Image Generation JS Library) to generate an image. Subsequently, the application reuses the same prompt and newly generated image to edit the image via the Image Edit services (via MindGallery provided Image Edit JS Library). The generated and edited images are stored and retrieved from the Image Blob Database. This architecture allows isolated applications to leverage the device's AI capabilities, enhancing flexibility and integration.

### Exhibit E

This exhibit demonstrates the preferred embodiment including a process to load a new AI model and generate images on the MindGallery device. The application requests a model via the AI Model Loader JS Library, which loads it from a server and stores it in the model database. The device captures user audio, passes it to the application code, the application code processes it via the MindGallery provided Speech Recognition JS Library, and then converts it into a prompt. The prompt and model ID are sent to the Image Generation Service via the MindGallery provided Image Generation JS Library, which generates an image using the previously loaded model. The image is stored in the Image Blob Database, and retrieved for display on the device. This flow demonstrates the integration of new models and user-driven image generation.

### DETAILED INVENTION DESCRIPTION

The “MindGallery” device starts with the development of a high-quality FCC certified 32-inch IPS touchscreen display. The display boasts a resolution of 1920×080 pixels, a brightness of 350 cd/m², and a contrast ratio of 1000:1. The screen has an aspect ratio of 16:9 and a display area measuring 699×394 mm. It is powered by a Rockchip RK3566 quad-core processor clocked at 2.0 GHz, complemented by 2 GB of RAM and 16 GB of ROM, and runs on the Android 11.0 operating system.

Connectivity options for the “MindGallery” include WIFI 802.11b/g/n, an RJ45 Ethernet network interface, and Bluetooth 4.0. The device supports external 3G/4G USB dongles for additional connectivity. It also features various input and output ports, including one SD card slot supporting up to 32 GB, one USB OTG port, two USB 2.0 interfaces, a 3.5 mm headphone jack, and a 4.0 mm power DC jack. Multimedia capabilities include support for video formats like MPEG-1, MPEG-2, MPEG-4, H.263, H.264, and RV, with a maximum resolution of 1080P, as well as audio formats such as MP3, WMA, and AAC, and image formats like JPEG and JPG.

The display is encased in a custom-designed polyester frame with a silver brush finish. The frame dimensions are 33.5 inches by 21 inches, with a thickness of approximately 3 inches. The frame secures the display using heavy-duty turn button fasteners, tightened with screws to ensure a firm hold. The combined weight of the display and frame is approximately 25 lbs. The frame features a laser-engraved “MINDGALLERY” logo centered at the bottom panel, adding a distinctive touch. The current frame composition is subject to change.

Upon the first power-on, users are guided through a bootstrap application for initial setup. This includes connecting to a WiFi network, setting up user authentication/device linking, and downloading the latest version of the main “MindGallery” application. After the initial setup, the device automatically launches the main application on subsequent power-ons, providing a seamless user experience. The “MindGallery” software is designed to interact exclusively with the device's hardware, ensuring a focused and immersive user experience.

The main app is a combination of Java and Kotlin code arranged into various activities corresponding to image generation, image display, settings, speech recognition, device utility, payments, and more. The Image Display activity serves as a home screen for the device, it is from here that we determine user intent for the majority of the program. At its core, the activity leverages Kotlin's coroutines for asynchronous task handling, ensuring that UI responsiveness is maintained while background operations are executed. This is crucial for tasks such as loading image generations from files and performing health checks on the device's status. By utilizing coroutines, the activity can efficiently manage these operations without blocking the main UI thread.

The activity's interaction with the user is multifaceted. It includes elements for generating and editing images based on user input, particularly through speech recognition. This allows users to verbally command the generation or editing of images, adding a layer of convenience and accessibility to the application. The activity's ability to interpret user intent and initiate the appropriate image processing flows demonstrates a high level of user-centric design.

Furthermore, the activity integrates error handling mechanisms to address various scenarios, such as failed image generation or inappropriate user input. By handling these situations gracefully, the activity ensures a smooth user experience and prevents disruptions that could lead to user frustration.

The user interface elements, including settings buttons and animations, are thoughtfully designed to enhance the overall user experience. Animations, such as fade-in effects, are used to provide visual feedback and improve the perceived responsiveness of the application. Additionally, the inclusion of interactive elements, like settings buttons, adds depth to the user interface and enables users to customize their experience.

We will now deep dive into the most important code structures leveraged and navigated to from this home activity. These include the image generation flow, image edit flow, foundational structure for supporting the introduction and hosting of 3rd party apps, and the foundational structure supporting 3rd party apps with model loading. The preferred embodiment of the device supports image generation, image editing, image->video (animation) flow, community building features, image upload/export, and the foundational structure to support 1st party, 2nd party, and 3rd party AI based visual art apps.

### Image Generation (Reflected in Exhibit B)

# Step 1: Receive user audio
audio = receive_audio(user_audio)
# Step 2: Send audio to Speech Recognition Module
speech = speech_recognition_module.recognize(audio)
# Step 3: Generate prompt from recognized speech
prompt = application.generate_prompt(speech)
# Step 4: Send prompt to Image Generation Module
image_bytes = image_generation_module.generate(prompt)
# Step 5 + 6: Store image bytes in Image Blob DB
blob_id = image_blob_db.store(image_bytes)
# In Application Code
# Step 7 + 8 + 9: Retrieve Image Bytes from BlobId
image_bytes = image_blob_db.load(blob_id)
# Step 10: Display Image (Note: Step 10 is not shown in diagram)
display_image(image_bytes)

Image Generation Flow Happens with the Following Process:
1. Device receives user audio via
   a. on-device microphone after user touch OR
   b. push from an external source to the on device server
2. Audio is sent to the Speech Recognition Module-which detects the speech
3. Application code receives and converts the speech into a an AI model prompt
4. Application code sends the prompt to the Image Generation Module
5. Based on the prompt, the Image Generation Module generates an image (via an Image Generation AI model) and stores the resulting image in the Image Blob DB
6. Image Blob DB returns a Blob ID for the image bytes sent to the Image Generation Module
   a. The blob ID is a token that can be used to retrieve the image bytes later on
7. Image Generation Module returns that Blob ID to the Application Code
8. Application code sends the Blob ID to the Image Blob DB
9. Image Blob DB sends the image bytes to the Application code
10. Application Code displays the image on the device
   a. Note: Not displayed in the diagram

### Image Edit (Reflected in Exhibit C)

# Step 1: Receive user audio
audio = receive_audio(user_audio)
# Step 2: Send audio to Speech Recognition Module
speech = speech_recognition_module.recognize(audio)
# Step 3 + 4: Generate prompt from recognized speech
prompt = application.generate_prompt(speech)
old_blob_id = application.get_currently_displayed_image_blob_id( )
# Step 5: Retrieve Old Image Bytes from Image Blob DB
old_image_bytes = image_blob_db.load(old_blob_id)
# Step 6: Segment the old image based on bounding boxes
bounding_boxes = image_edit_module.segment_image(old_image_bytes, prompt)
# Step 7: Segmented image and bounding boxes via Image Generation Model a
new_image_bytes = image_generation_model.generate(prompt, segmented_image_bytes,
bounding_boxes)
# Step 8 + 9: Store new image bytes in Image Blob DB
# and send new blob_id and bounding boxes to application code.
new_blob_id = image_blob_db.store(new_image_bytes)
# In Application Code
# Step 10: Retrieve final Image Bytes from New Blob ID
final_image_bytes = image_blob_db.load(new_blob_id)
# Step 11: Display Final Image with bounding box (Note: Step 13 is not shown in
diagram)
display_image(final_image_bytes)

### Image Edit Flow Happens in the Following Process:

1. Device receives user audio via
   a. on-device microphone after user touch OR
   b. push from an external source to the on device server
2. Audio is sent to the Speech Recognition Module—which detects the speech
3. Application code receives and converts the speech into a an AI model prompt
4. Application code sends the prompt and the Blob ID of the currently displayed on device image to the Image Edit Module.
5. The Image Edit Module loads the image bytes of the old image (currently displayed image).
6. Image Segmentation Model generates bounding boxes based on the prompt and the old image bytes and sends both the bounding boxes and old image bytes to the image generation model.
7. Image Generation Model which generates a new image based on the prompt, bounding boxes, and old image bytes.
8. The new image bytes are stored in the Image Blob DB, and a new Blob ID is generated.
9. The bounding boxes and new image blob ID are sent to the application code.
10. The new image is loaded from the Image Blob DB using the new Blob ID.
11. The final image is displayed on the device.

### Segregated On-Device Apps (Reflected in Exhibit D)

# Step 1: Receive user audio
audio = receive_audio(user_audio)
# Step 2 + 3 + 4: Recognize audio from speech via this flow:
# request <−> speech recognition JS lib <−> on device server <−> speech recog.
service
speech_recognition_request = speech_recognition_request(audio, ...)
speech = speech_recognition_js_library.recognize(speech_recognition_request)
# Step 5 + 6 + 7: Generate image based on speech via flow:
# request <−> image gen js lib <−> on device server <−> image gen service
generate_image_request = create_generate_image_request(speech, ...)
gen_image_blob_id = image_gen_js_library.generate(generate_image_request)
# Step 8 + 9 + 10 + 11 + 12 : Edit image based on new image + speech via flow:
# request <−> image edit js lib <−> on device server <−> image edit service
edit_image_request = create_edit_image_request(gen_image_blob_id, speech, ..)
edited_image_blob_id = image_edit_js_library.edit_image(edit_image_request)
# Step 13 + 14: Retrieve Image Bytes from final Blob ID
final_image_bytes = image_blob_js_library.load(edited_image_blob_id)
# Step 15: Display Final Image(Note: Step 15 is not shown in diagram)
js_application.display_image(final_image_bytes)

Segregated on Device Applications (apps) can Interact with On Device AI Backed Services in the Following Way:
1. User audio is passed to a segregated Native JavaScript (JS) application. The device receives user audio via
   a. on-device microphone after user touch OR
   b. push from an external source to the on device server
2. The application passes the audio to the Speech Recognition JS Library
3. The Speech Recognition JS Library sends the audio to the on-device Speech Recognition Service—which detects the speech
   a. The Speech Recognition Service is exposed as a service on the device to segregated apps
4. The Speech Recognition Service sends back the detected speech
5. The Application receives the speech (with the Speech Recognition JS Library as an intermediary), converts the speech into an AI model prompt, and sends it to the Image Gen JS Library.
6. The Image Gen JS Library sends the prompt to the on-device Image Gen Service
7. The Image Gen Service generates an image based on the prompt, stores it to image blob DB, and sends back the identifying image blob ID
8. The Application receives the image blob ID (with the Image Gen JS Library as an intermediary), reuses the original prompt as an edit prompt, and sends the image blob ID and prompt to the Image Edit JS Library
9. The Image Edit JS Library sends the image blob ID and edit prompt to the on-device Image Edit Service.
10. The Image Edit Service sends the original image blob ID to Image Blob DB
11. Image Blob DB sends the image blob bytes to Image Edit Service
12. Image Edit Service edits the image, stores the bytes in Image Blob DB, and sends the blob ID identifying the edited image bytes to Image Edit JS Library which passes it to the application
13. Via Image Blob Js Library, the application sends the edit image blob ID to Image Blob DB
14. Image Blob DB sends the image bytes for the edit blob ID to the Image Blob JS Library
15. Image Blob JS Library sends the image bytes to the application
16. The application displays the edited image on the device.

Note: Javascript Libraries mentioned above are provided by MindGallery for use by segmented applications.

### Model Loading (Reflected in Exhibit E)

```
# Step 1 + 2 + 3 + 4 + 5: JS Application code requests a new AI model
# via AI Model Loader JS Model via this flow:
# app <−> js library <−> request <−> on device server <−> ai loading module <−>
# model server
model_id = ai_model_loader_js_library.download(create_load_model_request( ))
class AILoadingModule:
  def download(request):
    # Step 3: AI loading module load model bytes from model server
    model_bytes = load_module(request)
    # Step 4: Save model bytes to DB
    model_id = model_db.save(model_bytes)
    return model_id
# Step 6: Receive user audio
audio = receive_audio(user_audio)
# Step 7 + 8 + 9: Recognize audio from speech via this flow:
# request <−> speech recognition js lib <−> on device server <−> speech recog.
module
speech_recognition_request = speech_recognition_request(audio, ...)
speech = speech_recognition_js_library.recognize(speech_recognition_request)
# Step 10 + 11 + 12 + 13 + 14 + 15 + 16: Generate image based on speech via flow:
# request <−> image gen js lib <−> on device server <−> image gen module <−>
# model db
generate_image_request = create_generate_image_request(speech, model_id, ...)
gen_image_blob_id = image_gen_js_library.generate(generate_image_request)
class ImageGenJsLibrary:
  def generate(request):
    # Step 13: Load model bytes from model db and generate image
    model_bytes = model_db.load(request.model_id)
    generated_image_bytes = generate_image(request.prompt, model_bytes)
    # Step 14 + 15: Store generated image bytes into storage
    blob_id = image_db.save(generated_image_bytes)
    request blob_id
# Step 17: Retrieve Image Bytes from final Blob ID
final_image_bytes = image_blob_db.load(gen_image_blob_id)
# Step 18: Display Final Image(Note: Step 18 is not shown in diagram)
js_application.display_image(final_image_bytes)
```

### Segregated App Loading a New Model Happens in the Following Process:

1. The application requests a new AI model to be loaded via AI Model Loader Javascript (JS) Library
2. AI Model Loader JS Library request an AI model to be loaded from the AI Loading Module
3. AI Loading Module loads an AI model from model server
4. AI Loading Module stores the model bytes to model DB and receives a model ID
5. AI Loading Module passes the model ID back to the application via AI Model Loader JS Library
6. Device receives user audio via
   a. on-device microphone after user touch OR
   b. push from an external source to the on device server
7. The application sends the audio to the Speech Recognition JS Library
8. Speech Recognition JS Library sends the audio to the Speech Recognition Module—which detects the speech
9. Speech Recognition Module sends the speech back to the application code via Speech Recognition JS Library; the applicated code converts the speech into a an AI model prompt
10. Application code sends the prompt to the Image Generation JS Library
11. Image Generation JS Library packages the prompt and previously loaded model ID into a request object and sends that request to the Image Generation Module
12. Image Generation Module sends the model ID to model DB
13. Model DB sends the model bytes to the Image Generation Module
14. Based on the prompt, the Image Generation Module generates an image using the previously loaded model bytes and stores the resulting image in the Image Blob DB
15. Image Blob DB returns a Blob ID for the image bytes
   a. The blob ID is a token that can be used to retrieve the image bytes later on
16. Image Generation Module returns that Blob ID to the Application
17. The application sends the Blob ID to the Image Blob DB
18. Image Blob DB sends the image bytes to the Application
19. The application displays the image on the device
   a. Note: Not displayed in the diagram

1. An AI powered dedicated digital art display system comprising:
A display with touch screen or remote input interface capable of rendering digital images and receiving touch, audio, or text inputs.
A voice recognition module for deciphering user prompts where in the device ensures voice recognition is activated only after touching the screen or via an approved user action via linked remote input device.
An AI engine leveraging one or more generative AI models to generate media based on inputted prompts.
An ability for users to store and display generated content in the format of a digital art display.
A primary function of generating and displaying AI content/art, either as a singular/sole capability or in conjunction with other display capabilities.

2. A system for utilizing generative AI to edit digital art directly on a dedicated digital art display, comprising:
A touch screen or remote input interface capable of rendering digital images and receiving touch and/or audio inputs.
A voice recognition module for transcribing vocal commands.
A edit region selection module which selects which region to edit based on touch gestures and/or user vocal prompts.
An edit engine module which leverages one or more AI models to replace the edit region with new content images based on user vocal prompt.
Means for seamlessly replacing selected areas with newly AI generated image snippets based on the detected region.

3. A digital display intended to serve as a dedicated hub for a plethora of AI-based, visual arts based, generative models and tools, comprising:
Means for housing 1st, 2nd, and 3rd party AI based applications.
On-device applications have access to free of charge on device generative AI engines.
AI engine module is able to generate/edit content.
AI engine module can use one or more generative models that accept various types of input content (image, video, audio, speech, and/or text) and to generate various diverse media content (image, video, audio, speech, and/or text).
AI engine modules can use one or more generative models that accept various types of input content (image, video, audio, speech, and/or text) to edit the content.
Device displays generated/edited content.

4. The system/device of claim 1, wherein the utilized AI engines (either existing or proprietary) can also generate videos, audio, or speech content based on user prompts.

5. The digital art display device of claim 1, further comprising means for receiving or recording video, sound, and image inputs to create customized generative AI content.

6. The system/device of claim 1, wherein the device can provide conversational speech responses to the user relating to the process of generating the content and/or analysis of the generated content.

7. The method of claim 1, further comprising the step of storing generated images in a user gallery for future edit, display, or export.

8. The method of claim 1, further comprising the step of allowing users to select predefined styles (provided by 1st, 2nd, or 3rd parties) that shape the generation of images along specific stylistic rules.

9. The digital art display system of claim 1, wherein the touch screen ensures voice recognition is activated only after a touch input to enhance security and accuracy.

10. The digital art display device of claim 1, wherein the device supports horizontal user interactions such as messaging, trading generated pieces, and community promotions.

11. The system/device of claim 2, wherein the AI engine can also edit videos, audio, and speech content based on user prompts.

12. The system/device of claim 2, wherein the device can provide conversational speech responses to the user relating to the process of editing the content and/or analysis of the and/or analysis of the edited content.

13. The method of claim 2, further comprising the step of allowing users to select predefined styles (provided by 1st, 2nd, or 3rd parties) that shape the generation of images to mimic specific content. follow specific artistic rules.

14. The digital display of claim 3, wherein an external software process can push input content to the device to be used as input to content generation and editing; content can be pushed via API calls to an on-device server and/or a central server that pushes data to a given device.

15. The digital display of claim 3, wherein the device can support multiple devices coordinated to display portions of a shared larger image or video.

16. The digital display of claim 3, wherein the device can have memory customized by user input content (images, video, audio, speech, text) to impact future content generation.

17. The digital display of claim 3, wherein the device can have segregated applications customized to generate content in different ways in response to different content input for specific users.
